(19) United States
(12) Patent Application Publication
(10) Pub. No.: US 2016/0302609 A1
(43) Pub. Date: Oct. 20, 2016

(54) BEVERAGE PREPARATION APPARATUS

(71) Applicant: SHARP KABUSHIKI KAISHA, Osaka-shi (JP)

(72) Inventors: Yasuaki SAKANE, Osaka-shi (JP); Masayuki UNO, Osaka-shi (JP); Kazuya KITATANI, Osaka-shi (JP); Akihiro YOSHIDOME, Osaka-shi (JP); Hidekazu SHIMA, Osaka-shi (JP); Masaru MISUMI, Osaka-shi (JP)

(73) Assignee: Sharp Kabushiki Kaisha, Osaka-shi (JP)

(21) Appl. No.: 15/100,519

(22) PCT Filed: Jan. 26, 2015
(86) PCT No.: PCT/JP2015/052050

§ 371 Date: May 31, 2016

(30) Foreign Application Priority Data
Jan. 31, 2014 (JP) 2014-016467

(51) Int. Cl. A47J 31/40; A47J 43/046

(52) U.S. Cl. CPC A47J 31/40; A47J 43/0465

(57) ABSTRACT

A beverage preparation apparatus prepares a beverage with a liquid and powders, and includes an agitation unit including an agitation blade which agitates the liquid and the powders and an agitation tank which accommodates the agitation blade, an agitation blade drive portion which rotationally drives the agitation blade, and a control portion which controls the agitation blade drive portion. The agitation blade has a central axis of rotation and is provided with a plurality of blade portions surrounding the central axis of rotation. The control portion controls the agitation blade drive portion so as to switch between forward rotation and reverse rotation of the agitation blade.

### TECHNICAL FIELD

The present invention relates to a beverage preparation apparatus for preparing a beverage by using a liquid and powders obtained by grating an object to be grated.

### BACKGROUND ART

Conventionally, beverage supply apparatuses such as a tea dispenser and a coffee machine include not only apparatuses supplying drinks by supplying powders and hot water but also apparatuses including an agitation unit for foaming milk.

For example, Japanese Patent Laying-Open No. 2011-245315 (PTD 1) discloses an agitation unit which can agitate only a liquid such as milk and producing fine foams.

The agitation unit disclosed in PTD 1 includes an agitation blade including a blade portion in a coil shape which is formed from a series of winding portions formed from an annular wire and an agitation tank which accommodates the agitation blade.

### CITATION LIST

### Patent Document

PTD 1: Japanese Patent Laying-Open No. 2011-245315

### SUMMARY OF INVENTION

### Technical Problem

The agitation unit disclosed in PTD 1, however, aims to produce foams by agitating only a liquid, and it has not necessarily been optimal for agitation of a liquid and finely particulated powders obtained from tea leaves.

When an agitation blade including a blade portion in a coil shape is employed, agitation is not strong and powders cannot sufficiently be agitated. Therefore, powders are not uniformly and sufficiently diffused, a lump of powders remain, and agitation of powders and production of fine foams cannot both be achieved.

The present invention was made in view of the problems as described above, and an object of the present invention is to provide a beverage preparation apparatus which can efficiently agitate powders in agitation of powders and a liquid and also can produce fine foams.

### Solution to Problem

A beverage preparation apparatus based on a first aspect of the present invention is a beverage preparation apparatus for preparing a beverage with a liquid and powders, and includes an agitation unit including an agitation blade which agitates the liquid and the powders and an agitation tank which accommodates the agitation blade, an agitation blade drive portion which rotationally drives the agitation blade, and a control portion which controls the agitation drive portion. The agitation blade has a central axis of rotation and is provided with a plurality of blades surrounding the central axis of rotation. The control portion controls the agitation blade drive portion so as to switch between forward rotation and reverse rotation of the agitation blade.

In the beverage preparation apparatus based on the first aspect of the present invention, preferably, the control portion controls the agitation blade drive portion such that the agitation blade rotates in a forward direction and thereafter it rotates in a reverse direction.

In the beverage preparation apparatus based on the first aspect of the present invention, preferably, the control portion controls the agitation blade drive portion such that the agitation blade rotates at a first speed during forward rotation and rotates at a second speed lower than the first speed during reverse rotation.

A beverage preparation apparatus based on a second aspect of the present invention is a beverage preparation apparatus for preparing a beverage with powders, and includes an agitation unit including an agitation blade which agitates the powders and a liquid and an agitation tank which accommodates the agitation blade, an agitation blade drive portion which rotationally drives the agitation blade, and a control portion which controls the agitation blade drive portion. The agitation blade has a central axis of rotation and is provided with a plurality of blades surrounding the central axis of rotation. The control portion controls the agitation blade drive portion such that the agitation blade rotates at a first speed and thereafter the agitation blade rotates at a second speed lower than the first speed.

In the beverage preparation apparatus according to the first aspect and the second aspect of the present invention, preferably, the agitation tank includes a vessel main body in a cylindrical shape with bottom which has an opening portion opening upward and a lid portion which closes the opening portion. Preferably, the lid portion has a powder inlet for introducing the powders into the agitation tank. In this case, preferably, the powder inlet is provided at a position not superimposed on the agitation blade when viewed in a direction of the central axis of rotation.

In the beverage preparation apparatus according to the first aspect and the second aspect of the present invention, preferably, the vessel main body has a bottom surface portion and a circumferential wall portion erected from a circumference of the bottom surface portion. In this case, the powder inlet is preferably provided above the bottom surface portion such that powders are introduced onto substantially a center between a center of the bottom surface portion and a boundary portion between the bottom surface portion and the circumferential wall portion, on a second virtual line orthogonal at the center of the bottom surface portion to a first virtual line which connects the center of the bottom surface portion and the central axis of rotation to each other, when viewed in the direction of the central axis of rotation.

The beverage preparation apparatus according to the first aspect and the second aspect of the present invention preferably further includes a liquid storage tank which stores the liquid, a liquid supply path connected to the liquid storage tank for supplying the liquid to the agitation tank, a heating device which heats the liquid in the liquid supply path, a check valve which is provided in the liquid supply path and prevents backflow of the liquid in the liquid supply path to the liquid storage tank as the liquid is heated by the heating device, and a liquid amount sensing portion which senses an amount of the liquid supplied to the agitation tank. The liquid amount sensing portion preferably includes a temperature sensing portion which senses a temperature of the heating device and the control portion. In this case, preferably, a temperature of the heating device varies depending on an amount of the liquid in the liquid supply path, which fluctuates as the liquid is supplied to the agitation tank, and the control portion turns off the heating device when a temperature of the heating device sensed by the temperature sensing portion exceeds a prescribed temperature, and counts a duration of power supply until the heating device is turned off. The liquid amount sensing portion preferably senses an amount of the liquid supplied to the agitation tank based on the duration of power supply.

### Advantageous Effects of Invention

According to the present invention, a beverage preparation apparatus which can efficiently agitate powders in agitation of powders and a liquid and also can produce fine foams can be provided.

### BRIEF DESCRIPTION OF DRAWINGS

FIG. 1 is an overall perspective view of a beverage preparation apparatus in an embodiment.

FIG. 2 is a cross-sectional view along the line II-II in FIG. 1.

FIG. 3 is an overall perspective view showing a schematic component of the beverage preparation apparatus in a first embodiment.

FIG. 4 is a block diagram showing a configuration of the beverage preparation apparatus in the first embodiment.

FIG. 5 shows a first preparation flow showing discharge of tea using the beverage preparation apparatus in the first embodiment.

FIG. 6 shows a second preparation flow showing discharge of tea using the beverage preparation apparatus in the first embodiment.

FIG. 7 shows a third preparation flow showing discharge of tea using the beverage preparation apparatus in the first embodiment.

FIG. 8 is a perspective view showing an internal structure of the beverage preparation apparatus in the first embodiment.

FIG. 9 is a perspective view of a milling unit in the first embodiment.

FIG. 10 is an exploded perspective view of the milling unit in the first embodiment.

FIG. 11 is a vertical cross-sectional view of the milling unit in the first embodiment.

FIG. 12 is a perspective view of an agitation unit in the first embodiment.

FIG. 13 is a vertical cross-sectional view of the agitation unit in the first embodiment.

FIG. 14 is a plan view showing a shape of an agitation blade in the first embodiment.

FIG. 15 is a perspective view showing the shape of the agitation blade in the first embodiment.

FIG. 16 is an exploded perspective view showing a structure of the agitation blade in the first embodiment.

FIG. 17 is a cross-sectional view along the line XVII-XVII in FIG. 14.

FIG. 18 is a flowchart showing details of the step of starting agitation in the first embodiment.

FIG. 19 is a diagram showing an agitation operation by the agitation blade in the first embodiment.

FIG. 20 is a diagram showing a position of introduction of tea leaf powders in an agitation tank in the first embodiment.

FIG. 21 is a diagram showing a state of tea leaf powders after agitation when tea leaf powders were dropped in an A region shown in FIG. 20.

FIG. 22 is a diagram showing a state of tea leaf powders after agitation when tea leaf powders were dropped in a B region shown in FIG. 20.

FIG. 23 is a diagram showing a state of tea leaf powders after agitation when tea leaf powders were dropped in a C region shown in FIG. 20.

FIG. 24 is a flowchart showing details of the step of starting agitation in a beverage preparation apparatus in a second embodiment.

FIG. 25 is a block diagram showing a configuration of a beverage preparation apparatus in a third embodiment.

FIG. 26 is a flowchart showing details of the step of starting supply of hot water in the beverage preparation apparatus in the third embodiment.

FIG. 27 is a vertical cross-sectional view showing a part of an agitation unit and a main body structure of a beverage preparation apparatus in a fourth embodiment.

### DESCRIPTION OF EMBODIMENTS

A beverage preparation apparatus in the present embodiment will be described with reference to the drawings. In the drawings of the embodiments described below, the same or corresponding elements have the same reference numeral allotted and redundant description may not be repeated. When the number or an amount is mentioned in each embodiment, the scope of the present invention is not necessarily limited to the number or the amount unless otherwise specified.

In the present embodiment, though a case that tea leaves are used as an object to be grated and tea is prepared as a beverage will be described by way of example, the object to be grated is not limited to tea leaves, but the embodiment can also be applied to preparation of a beverage with cereals, dried goods, and other objects to be grated.

Hereinafter, tea leaves mean a solid state before grating, powder tea leaves mean grated tea leaves, and tea means a beverage obtained by agitating (mixing) tea leaf powders and hot water.

### First Embodiment

(Beverage Preparation Apparatus 1)

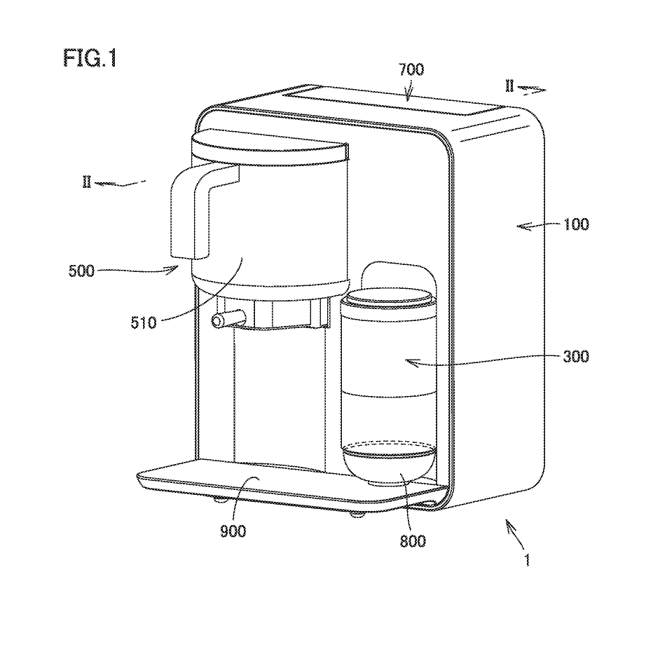

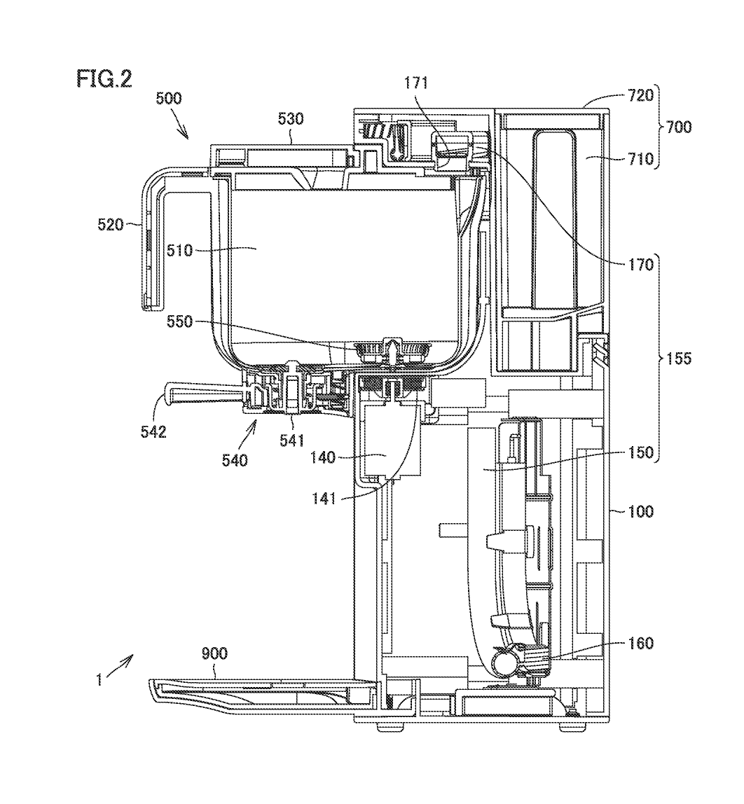

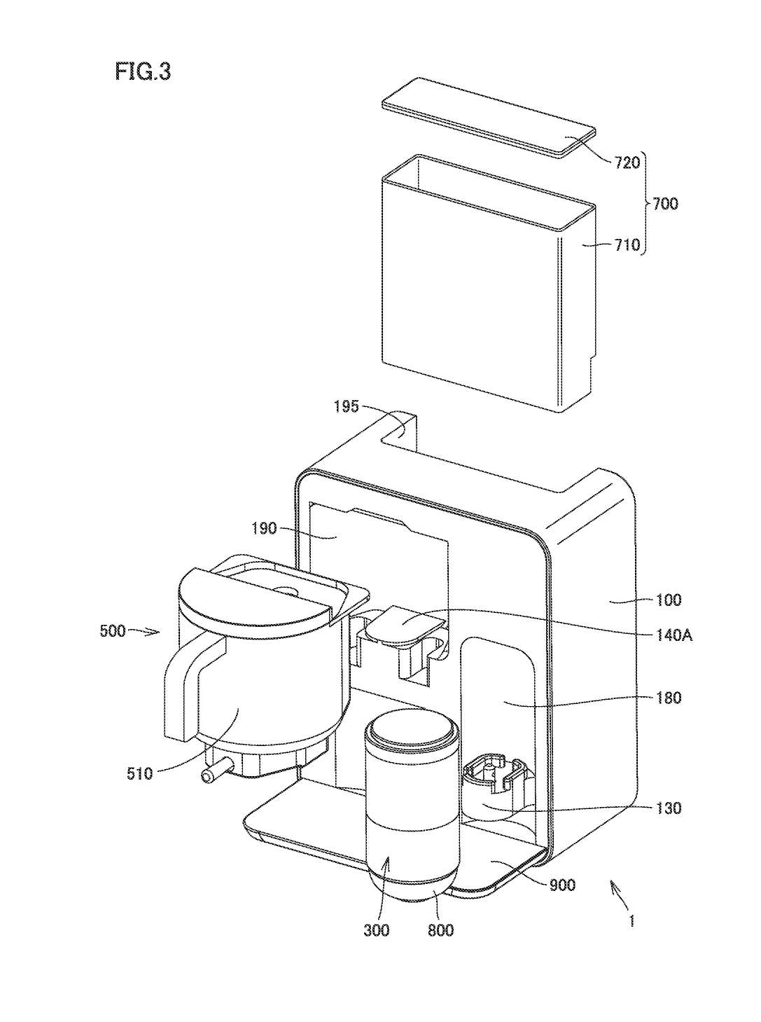

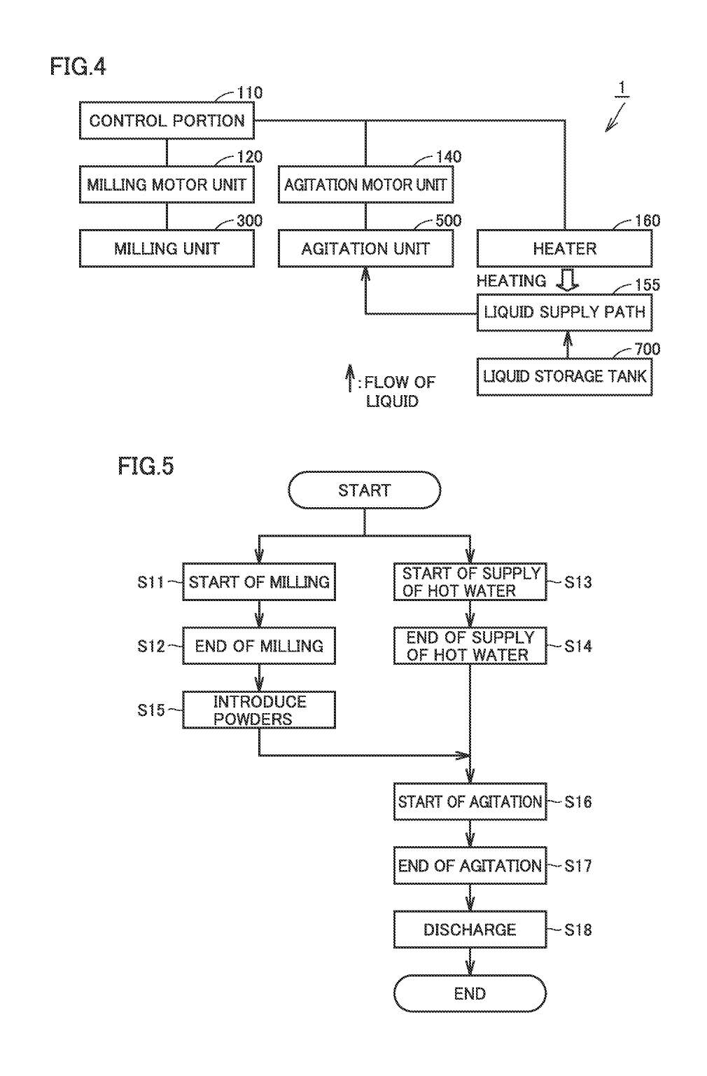

A beverage preparation apparatus 1 in the present embodiment will be described with reference to FIGS. 1 to 4. FIG. 1 is an overall perspective view of beverage preparation apparatus 1, FIG. 2 is a cross-sectional view along the line II-II in FIG. 1, and FIG. 3 is an overall perspective view of a schematic component of beverage preparation apparatus 1. FIG. 4 is a block diagram showing a control configuration of the beverage preparation apparatus.

As shown in FIGS. 1 to 3, beverage preparation apparatus 1 uses tea leaves as an object to be grated and obtains tea leaf powders by grating the tea leaves. The beverage preparation apparatus uses the obtained tea leaf powders for preparing tea as a beverage. Beverage preparation apparatus 1 includes an apparatus main body 100 as a main body portion, a milling unit 300, an agitation unit 500, a liquid storage tank 700, a liquid supply path 155 (see FIG. 2), a tea leaf powder tray 800 as a powder reception portion, and a placement base 900. Placement base 900 is provided to protrude forward on a front side in a lower portion of apparatus main body 100 and a cup (not shown) and tea leaf powder tray 800 can be placed thereon. Tea leaf powder tray 800 is provided such that a user can hold and move the tray.

As shown in FIG. 4, beverage preparation apparatus 1 further includes a control portion 110, a milling motor unit 120, an agitation motor unit 140, and a heater 160. Control portion 110 controls operations of milling motor unit 120, agitation motor unit 140, and heater 160. Milling motor unit 120 drives milling unit 300, and agitation motor unit 140 drives agitation unit 500.

A liquid such as water stored in liquid storage tank 700 is introduced into liquid supply path 155. Water introduced into liquid supply path 155 is heated by heater 160 to hot water, which is in turn supplied to agitation unit 500.

(Milling Unit 300) As shown in FIGS. 1 to 3, milling unit 300 is removably attached to a milling unit attachment portion 180 provided on a front surface side of apparatus main body 100. Milling unit 300 is arranged at a distance from an agitation tank 510 so as not to be superimposed on agitation tank 510 under agitation tank 510 included in agitation unit 500 when viewed from the front.

A milling driving force coupling mechanism 130 is provided in milling unit attachment portion 180 so as to protrude forward and milling unit 300 is removably attached to this milling driving force coupling mechanism 130. Milling unit 300 obtains driving force for milling tea leaves representing an object to be grated by being coupled to milling driving force coupling mechanism 130.

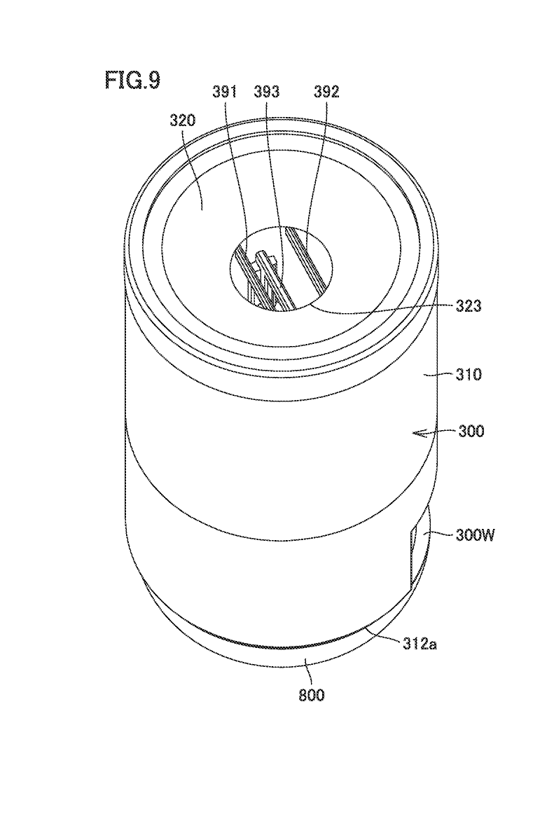

Tea leaves introduced from an upper portion of milling unit 300 into milling unit 300 are finely grated in milling unit 300. The grated tea leaves are dropped and collected as tea leaf powders on tea leaf powder tray 800 placed below milling unit 300. A detailed structure of milling unit 300 will be described later with reference to FIGS. 9 to 11.

(Liquid Storage Tank 700)

Liquid storage tank 700 is removably attached to a liquid storage tank attachment portion 195 provided on an upper surface side of apparatus main body 100. Liquid storage tank 700 includes a tank main body 710 having an opening in an upper surface and a lid portion 720 closing the opening in the upper surface of tank main body 710. Liquid storage tank 700 stores such a liquid as water which is introduced from the outside after lid portion 720 is removed.

(Liquid Supply Path 155)

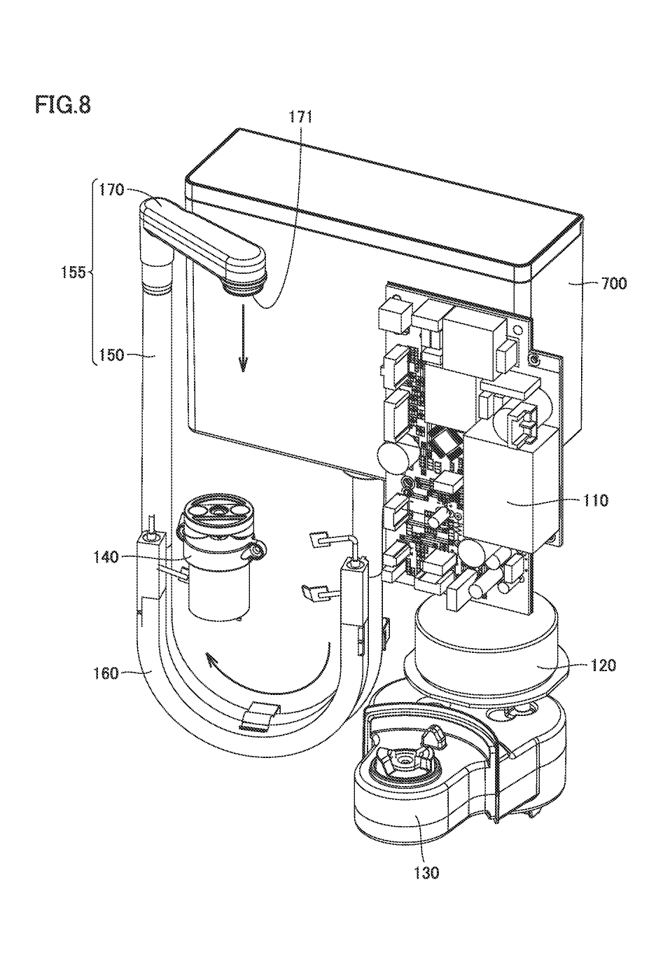

Liquid supply path 155 is accommodated in apparatus main body 100. Liquid supply path 155 is connected to liquid storage tank 700 (see FIG. 8). Liquid supply path 155 is provided with a supply port 171 on a side opposite to a side where liquid storage tank 700 is connected. Liquid supply path 155 includes a hot water supply pipe 150 and a hot water supply nozzle 170. Hot water supply pipe 150 has one end side connected to liquid storage tank 700 and the other end side connected to hot water supply nozzle 170. A liquid introduced from liquid storage tank 700 into liquid supply path 155 is supplied to agitation unit 500 through hot water supply pipe 150 and hot water supply nozzle 170.

(Agitation Unit 500)

Agitation unit 500 includes an agitation blade 550 for agitating a liquid and powders and agitation tank 510 accommodating agitation blade 550. Agitation tank 510 is removably attached to an agitation tank attachment portion 190 provided on the front surface side of apparatus main body 100. Agitation tank 510 is attached to agitation tank attachment portion 190 so as to protrude from apparatus main body 100 in a direction intersecting with a vertical direction. Specifically, agitation tank 510 is attached such that a part of agitation tank 510 protrudes from a front surface of apparatus main body 100 along a direction of normal to the front surface.

An agitation motor contactless table 140A is provided in agitation tank attachment portion 190. Agitation unit 500 is placed on agitation motor contactless table 140A. Agitation blade 550 provided in agitation unit 500 is rotated by agitation motor unit 140 and a magnet 141 coupled thereto. Agitation motor unit 140 and permanent magnet 141 are accommodated in apparatus main body 100 so as to be located below agitation motor contactless table 140A. Agitation motor unit 140 corresponds to an agitation blade drive portion which rotationally drives agitation blade 550.

Hot water supply nozzle 170 is provided above agitation tank attachment portion 190 of apparatus main body 100. In apparatus main body 100, a temperature of water in hot water supply pipe 150 is raised to a prescribed temperature and hot water is supplied from hot water supply nozzle 170 into agitation tank 510. Hot water prepared in apparatus main body 100 and tea leaf powders obtained by milling unit 300 are introduced into agitation tank 510, and hot water and tea leaf powders are agitated by agitation blade 550 in agitation tank 510. Tea is thus prepared in agitation tank 510.

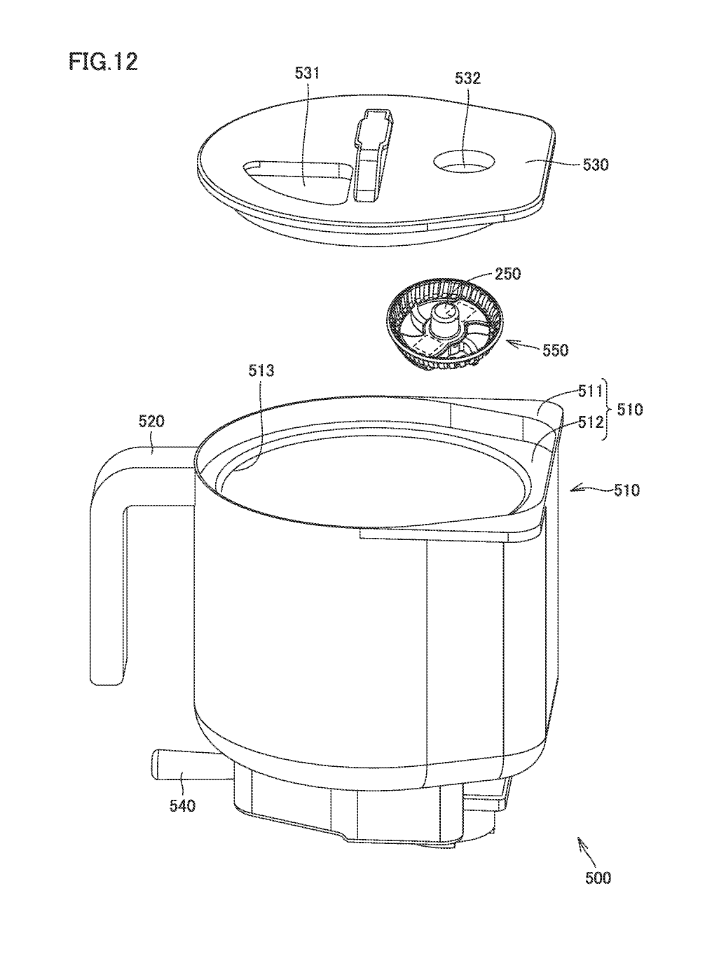

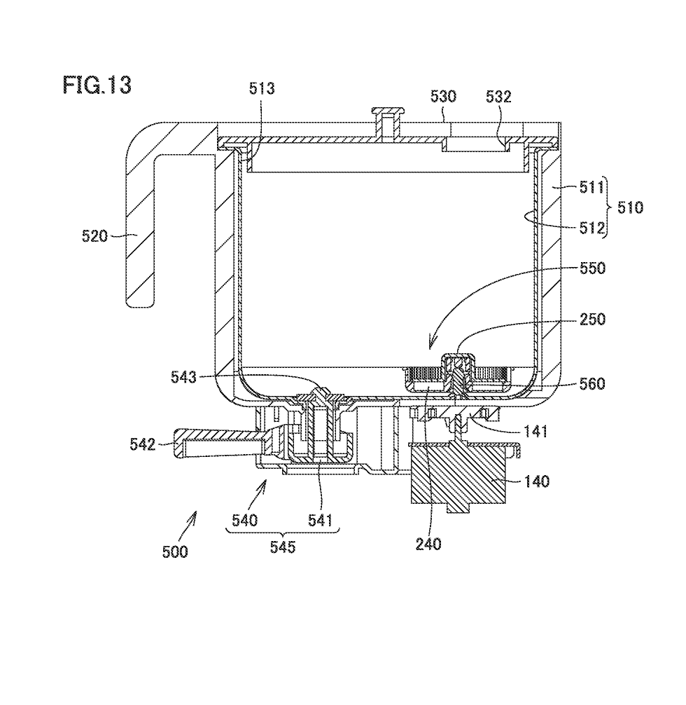

Tea prepared in agitation unit 500 can be poured into a cup (not shown) placed on placement base 900 by operating an operation lever 542 of a discharge port opening and closing mechanism 540 provided below agitation unit 500. A detailed structure of agitation unit 500 will be described later with reference to FIGS. 12 and 13.

(Flow of Preparation of Tea (Beverage))

A flow of preparation of tea (beverage) with the use of beverage preparation apparatus 1 will now be described with reference to FIGS. 5 to 7. FIGS. 5 to 7 show first to third preparation flows showing discharge of tea using beverage preparation apparatus 1, respectively. A prescribed amount of tea leaves is introduced into milling unit 300 and a prescribed amount of water is stored in liquid storage tank 700.

(First Preparation Flow)

A first preparation flow will be described with reference to FIG. 5. This first preparation flow is a flow in which grating of tea leaves in milling unit 300 and supply of hot water from apparatus main body 100 to agitation unit 500 are simultaneously carried out.

In beverage preparation apparatus 1, milling of tea leaves by milling unit 300 in a step 11 and supply of hot water from apparatus main body 100 to agitation unit 500 in a step 13 are simultaneously started. Then, milling of tea leaves by milling unit 300 ends in a step 12, and supply of hot water from apparatus main body 100 to agitation unit 500 ends in a step 14.

In a step 15, tea leaf powders obtained in step 12 are introduced into agitation unit 500 by a user.

Then, in a step 16, agitation of the tea leaf powders and hot water in agitation unit 500 is started. In a step 17, agitation of the tea leaf powders and hot water in agitation unit 500 ends. In a step 18, tea is discharged into the cup placed on placement base 900 as the user operates operation lever 542 of discharge port opening and closing mechanism 540 provided below agitation unit 500.

(Second Preparation Flow)

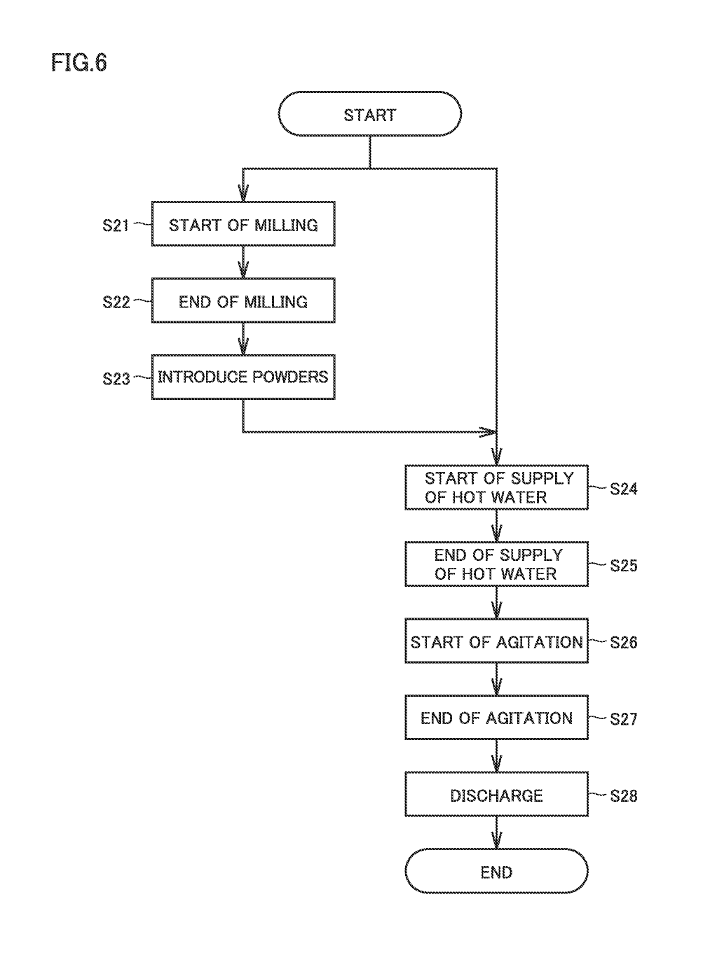

A second preparation flow will be described with reference to FIG. 6. This second preparation flow is a flow in which hot water is supplied from apparatus main body 100 to agitation unit 500 after tea leaves are grated in milling unit 300.

In beverage preparation apparatus 1, in a step 21, milling of tea leaves by milling unit 300 is started. In a step 22, milling of tea leaves by milling unit 300 ends. In a step 23, tea leaf powders obtained in step 22 are introduced into agitation unit 500 by a user.

In a step 24, supply of hot water from apparatus main body 100 to agitation unit 500 is started. In a step 25, supply of hot water from apparatus main body 100 to agitation unit 500 ends.

Then, in a step 26, agitation of the tea leaf powders and hot water in agitation unit 500 is started. In a step 27, agitation of the tea leaf powders and hot water in agitation unit 500 ends. In a step 28, tea is discharged into the cup placed on placement base 900 as the user operates operation lever 542 of discharge port opening and closing mechanism 540 provided below agitation unit 500.

(Third Preparation Flow)

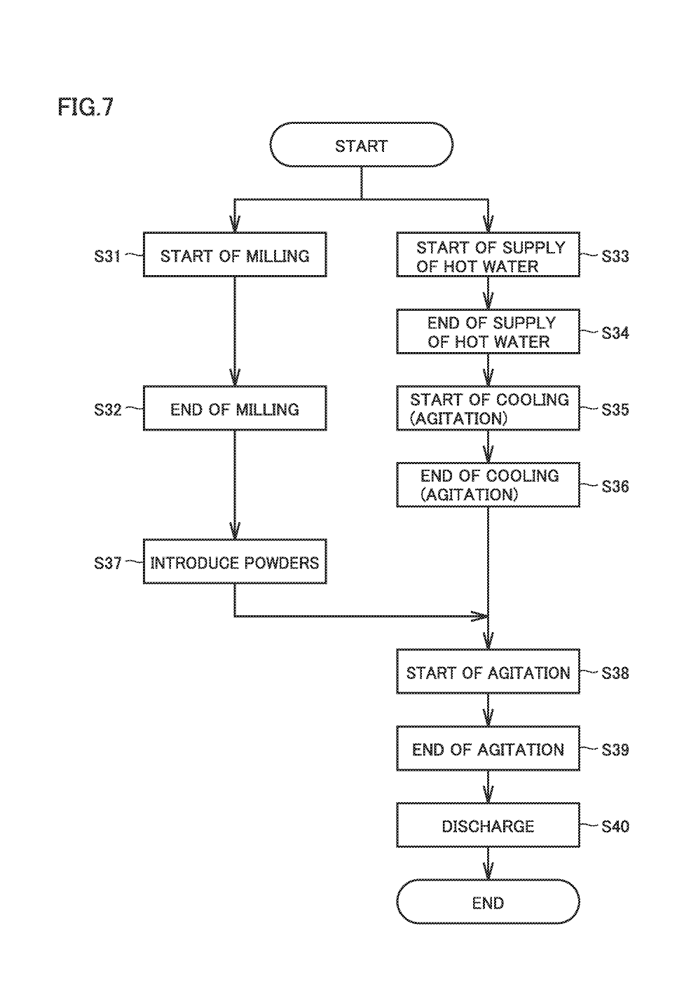

A third preparation flow will be described with reference to FIG. 7. This third preparation flow includes a step of cooling hot water by agitation in agitation unit 500.

In beverage preparation apparatus 1, milling of tea leaves by milling unit 300 in a step 31 and supply of hot water from apparatus main body 100 to agitation unit 500 in a step 33 are simultaneously started. In a step 34, supply of hot water from apparatus main body 100 to agitation unit 500 ends.

Then, in a step 32, milling of tea leaves by milling unit 300 ends, and in a step 35, cooling by agitation of hot water supply is started in agitation unit 500. In a step 36, cooling by agitation of hot water supply in agitation unit 500 ends.

In a step 37, the tea leaf powders obtained in step 32 are introduced into agitation unit 500 by a user.

Then, in a step 38, agitation of the tea leaf powders and hot water in agitation unit 500 is started. In a step 39, agitation of the tea leaf powders and hot water in agitation unit 500 ends. In a step 40, tea is discharged into the cup placed on placement base 900 as the user operates operation lever 542 of discharge port opening and closing mechanism 540 provided below agitation unit 500.

(Internal Structure of Apparatus Main Body 100)

An internal structure of beverage preparation apparatus 1 will now be described with reference to FIG. 8. FIG. 8 is a perspective view showing the internal structure of beverage preparation apparatus 1. In apparatus main body 100 of beverage preparation apparatus 1, a control portion 110 including a printed circuit board on which electronic components are mounted is arranged on a front surface side of liquid storage tank 700. Based on input of a start signal by a user, the flow for preparation of tea is executed by control portion 110.

Milling motor unit 120 for providing driving force to milling unit 300 is arranged at a position below control portion 110. Milling driving force coupling mechanism 130 provided to protrude forward for transmitting driving force of milling motor unit 120 to milling unit 300 is provided at a position below milling motor unit 120.

To a bottom surface of liquid storage tank 700, one end of hot water supply pipe 150 extending once downward from the bottom surface and then extending upward in a U shape is coupled. Hot water supply nozzle 170 for pouring hot water into agitation tank 510 of agitation unit 500 is coupled to an upper end portion of hot water supply pipe 150. A U-shaped heater 160 for heating water which passes through hot water supply pipe 150 is attached to an intermediate region of hot water supply pipe 150.

(Structure of Milling Unit 300)

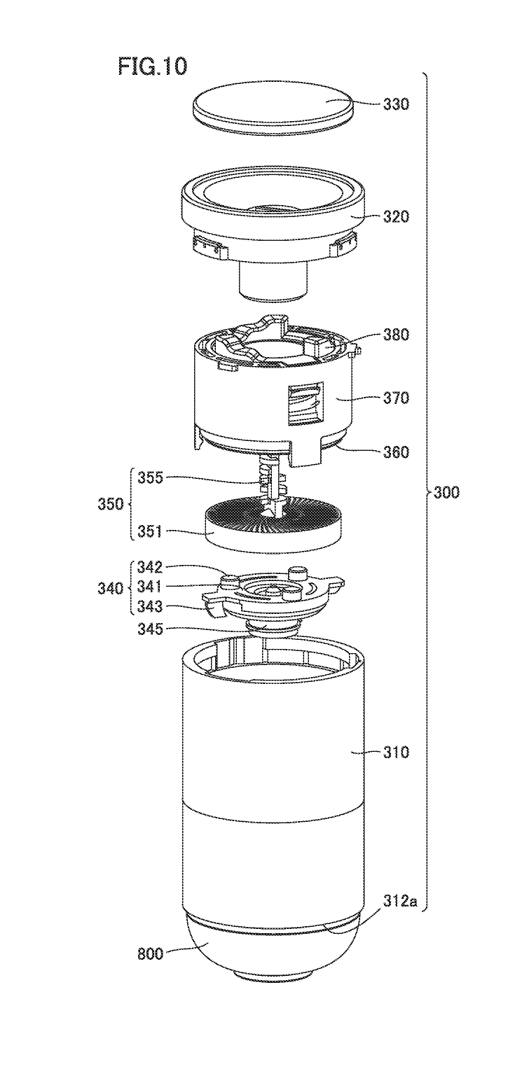

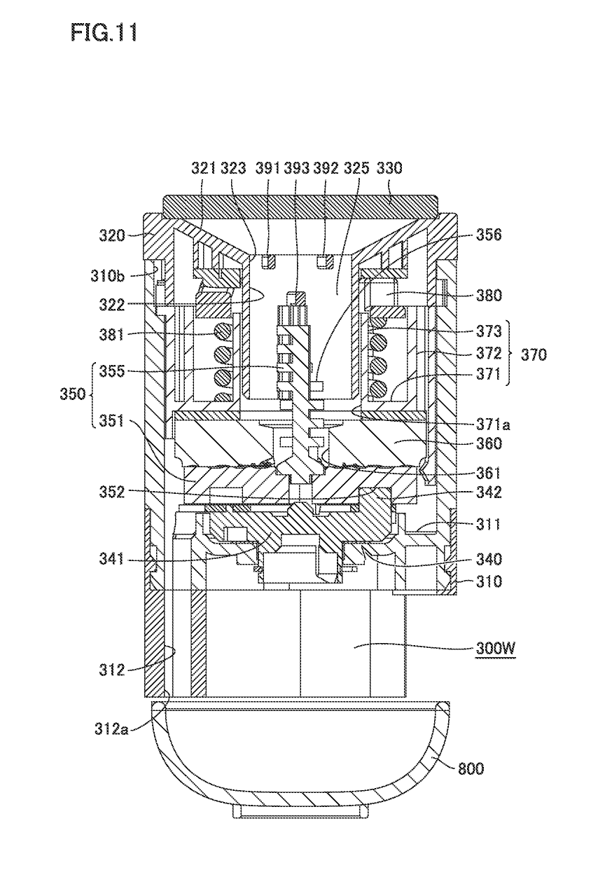

A structure of milling unit 300 will now be described with reference to FIGS. 9 to 11. FIG. 9 is a perspective view of milling unit 300, FIG. 10 is an exploded perspective view of milling unit 300, and FIG. 11 is a vertical cross-sectional view of milling unit 300.

Milling unit 300 has a milling case 310 having a cylindrical shape as a whole, and a window for coupling 300w in which milling driving force coupling mechanism 130 is inserted is provided in a side surface below. A storage portion 311 for storing tea leaf powders produced by a lower mill main body 351 and an upper mill 360 which will be described later and a discharge path 312 communicating with storage portion 311 are provided in milling case 310. An outlet port 312a for discharging tea leaf powders into tea leaf powder tray 800 is provided at a lower end portion of discharge path 312.

Milling unit 300 includes upper mill 360 and a lower mill portion 350 which grate an object to be grated and a lower mill portion support portion 340 to which lower mill portion 350 is attached. In milling case 310, lower mill portion support portion 340, lower mill portion 350, and upper mill 360 are successively provided from below. Lower mill portion support portion 340 supports lower mill portion 350 from a side opposite to a side where upper mill 360 is located, in an attachment state in which lower mill portion 350 has been attached. Lower mill portion support portion 340 has a substantially columnar main body portion 341, a protrusion portion 342, and a powder scraping portion 343. A milling shaft 345 is provided on a lower surface of main body portion 341 and extends downward. Milling shaft 345 is coupled to milling driving force coupling mechanism 130. Lower mill portion support portion 340 is thus rotatable while it supports lower mill portion 350.

Protrusion portion 342 is provided on an upper surface of main body portion 341 and protrudes upward. Protrusion portion 342 functions as a first locking portion for locking lower mill main body 351. Powder scraping portion 343 is provided around a circumferential portion of main body portion 341. Powder scraping portion 343 scrapes off tea leaf powders stored in storage portion 311 and transports the tea leaf powders to discharge path 312 as lower mill portion support portion 340 rotates.

Lower mill portion 350 includes lower mill main body 351 and a core 355. Lower mill main body 351 has a recess portion 352 provided in a lower surface. Recess portion 352 is provided at a position corresponding to protrusion portion 342 and locked by protrusion portion 342. Recess portion 352 functions as a second locking portion locked by the first locking portion. Lower mill main body 351 rotates in coordination with lower mill portion support portion 340.

Core 355 is provided in a central portion of lower mill main body 351 and provided to extend upward along a core of a rotation shaft of lower mill main body 351. Core 355 is provided to pass through a through hole 361 provided in a central portion of upper mill 360. Core 355 has a helically provided blade portion 356.

Upper mill 360 is held by an upper mill holding member 370 arranged above the upper mill. A not-shown hole portion is provided in an upper surface of upper mill 360. As a not-shown pin portion provided in upper mill holding member 370 enters the hole portion, rotation of upper mill 360 is prevented.

Upper mill holding member 370 includes a bottom surface portion 371 having a hole portion 371a, an outer cylindrical portion 372 erected upward from a circumference of bottom surface portion 371, and an inner cylindrical portion 373 erected upward from a circumference of hole portion 371a. Hole portion 371a is provided to communicate with through hole 361 in upper mill 360. A spring 381 pressing upper mill 360 downward and a part of a spring holding member 380 are accommodated in between outer cylindrical portion 372 and inner cylindrical portion 373. Spring 381 adjusts a grating pressure applied between upper mill 360 and lower mill main body 351.

A hopper portion 320 for supplying an object to be grated in between upper mill 360 and lower mill main body 351 is attached to a side of an upper end opening portion 310b of milling case 310. Hopper portion 320 has a top plate portion 321, a cylindrical portion 322, and an object-to-be-grated inlet 325. Top plate portion 321 has such a bowl shape that an opening portion 323 is provided substantially in a central portion. Cylindrical portion 322 is provided to extend downward from a circumference of opening portion 323. Cylindrical portion 322 is arranged in inner cylindrical portion 373. Object-to-be-grated inlet 325 is defined by opening portion 323 and cylindrical portion 322. Core 355 is accommodated in object-to-be-grated inlet 325.

In cylindrical portion 322, a plurality of linear ribs 391, 392, and 393 are provided across object-to-be-grated inlet 325. Specifically, two ribs 391 and 392 are provided in an upper portion of object-to-be-grated inlet 325, in parallel to each other. Two ribs 391 and 392 are provided at a distance from each other so as not to prevent drop of tea leaves.

One rib 393 is provided between two ribs 391 and 392, in parallel thereto, when viewed in a direction of a central axis of object-to-be-grated inlet 325. Rib 393 is provided below two ribs 391 and 392. In this case, rib 393 is preferably provided above a tip end of core 355.

By thus providing ribs 391, 392, and 393, a user's finger can be prevented from being caught in core 355 and safety can be ensured.

After tea leaves are introduced into object-to-be-grated inlet 325, in order to prevent entry of a foreign matter into milling unit 300 and in order to prevent grated tea leaves from scattering, hopper portion 320 is preferably covered with a cover portion 330. When tea leaves are to be introduced, cover portion 330 is removed from hopper portion 320.

Tea leaves introduced into object-to-be-grated inlet 325 are accommodated in a space defined by the upper surface of upper mill 360 exposed through upper mill holding member 370 and an inner circumferential surface of cylindrical portion 322. Tea leaves accommodated in the space are guided by helical blade portion 356 which rotates with rotation of lower mill main body 351 and sent in between upper mill 360 and lower mill main body 351.

Tea leaves sent in between upper mill 360 and lower mill main body 351 are grated and fall downward in a form of tea leaf powders from a circumference of upper mill 360 and lower mill main body 351. Some of fallen tea leaf powders is discharged through discharge path 312 into tea leaf powder tray 800 from outlet port 312a. Other fallen tea leaf powders are stored in storage portion 311. Tea leaf powders in storage portion 311 are transported into discharge path 312 by powder scraping portion 343 which rotates with rotation of lower mill portion support portion 340 and discharged from outlet port 312a into tea leaf powder tray 800.

(Structure of Agitation Unit 500)

A structure of agitation unit 500 will now be described with reference to FIGS. 12 and 13. FIG. 12 is a perspective view of agitation unit 500 and FIG. 13 is a vertical cross-sectional view of agitation unit 500.

Agitation unit 500 includes agitation tank 510, agitation blade 550, and an agitation cover 530. Agitation tank 510 includes an exterior holder 511 made of a resin and a thermally insulated tank 512 held by exterior holder 511. Thermally insulated tank 512 corresponds to a vessel main body of agitation tank 510. An integrally resin molded grip 520 is provided in exterior holder 511. Thermally insulated tank 512 has an opening portion 513 which has a cylindrical shape with bottom and opens upward.

Agitation cover 530 is attached to opening portion 513 so as to be able to open and close opening portion 513. Agitation cover 530 is provided with a powder inlet 531 for introducing tea leaf powders grated by milling unit 300 and a hot water supply inlet 532 through which hot water formed in apparatus main body 100 is poured from hot water supply nozzle 170. Hot water supply inlet 532 is provided at a position corresponding to supply port 171 of hot water supply nozzle 170.

Powder inlet 531 and hot water supply inlet 532 communicate with opening portion 513. Tea leaf powders introduced from moved tea leaf powder tray 800 to powder inlet 531 are introduced into thermally insulated tank 512 through opening portion 513. Hot water poured through hot water supply inlet 532 from hot water supply nozzle 170 is supplied into thermally insulated tank 512 through opening portion 513.

Agitation blade 550 is placed on a bottom portion of agitation tank 510. A rotation shaft 560 extending upward is provided on the bottom portion of agitation tank 510, and a cylindrical core 250 of agitation blade 550 is inserted in this rotation shaft 560.

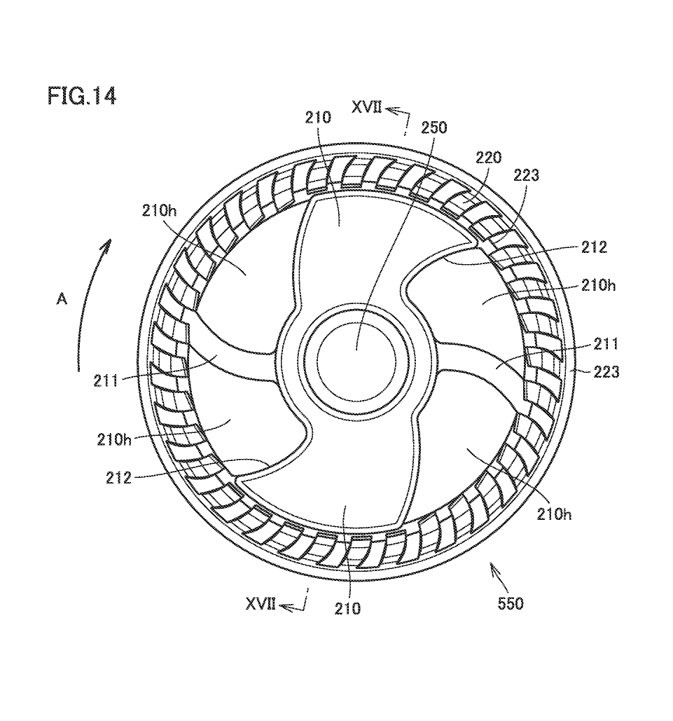

A permanent magnet 240 is embedded in agitation blade 550. In agitation motor contactless table 140A, permanent magnet 240 embedded in agitation blade 550 and permanent magnet 141 provided on a side of agitation motor unit 140 are magnetically coupled in a contactless state, so that rotational driving force of agitation motor unit 140 is transmitted to agitation blade 550. Details of agitation blade 550 will be described later with reference to FIGS. 14 to 17.

Agitation tank 510 further includes a discharge portion 545 for discharging a prepared beverage. Discharge portion 545 is provided in agitation tank 510 in a portion protruding from apparatus main body 100. Discharge portion 545 includes a discharge port 541 provided in the bottom portion of agitation tank 510 and discharge port opening and closing mechanism 540 opening and closing discharge port 541. Discharge port 541 is a portion for discharging tea prepared by agitation of tea leaf powders and hot water by agitation blade 550.

Discharge port opening and closing mechanism 540 includes an opening and closing nozzle 543 inserted into discharge port 541 so as to be able to open and close discharge port 541 and operation lever 542 controlling a position of opening and closing nozzle 543. Opening and closing nozzle 543 is biased to close discharge port 541 by a biasing member (not shown) such as a spring in a normal state. When a user moves operation lever 542 against biasing force, opening and closing nozzle 543 moves to open discharge port 541 and thus tea in agitation tank 510 is poured into a cup (not shown) placed on placement base 900.

Prepared tea may be high in viscosity depending on a type of tea leaves and an amount of tea leaf powders. In such a case, it may take time to completely pour tea in the agitation tank through discharge port 541.

In such a case, agitation tank 510 may be removed from agitation tank attachment portion 190 and agitation cover 530 may be removed from opening portion 513, so that tea is poured into a cup through opening portion 513 by tilting agitation tank 510.

A lip portion may be provided in agitation tank 510 such that a part of opening portion 513 is exposed through agitation cover 530. In this case, tea can be poured into a cup from the lip portion after agitation tank 510 is removed from agitation tank attachment portion 190, without removing agitation cover 530 from opening portion 513. Furthermore, in this case, agitation tank 510 may be constructed such that hot water can be supplied from the lip portion in supplying hot water from hot water supply nozzle 170 into agitation tank 510.

(Structure of Agitation Blade 550)

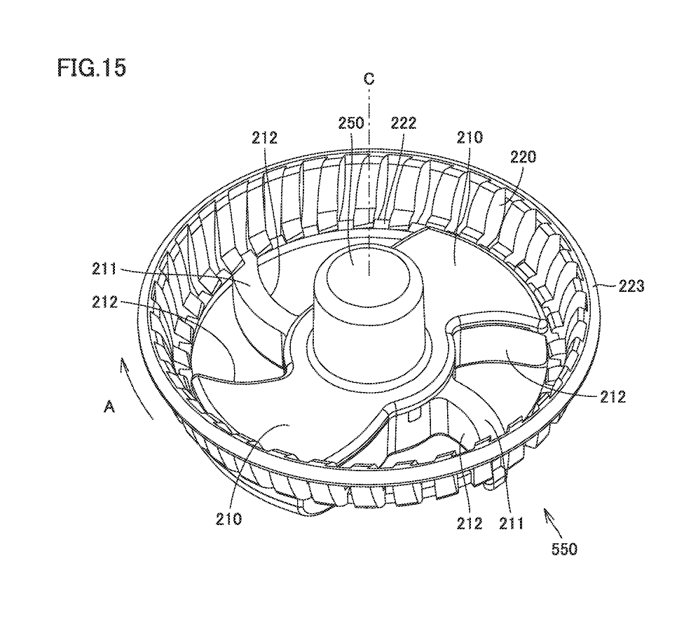

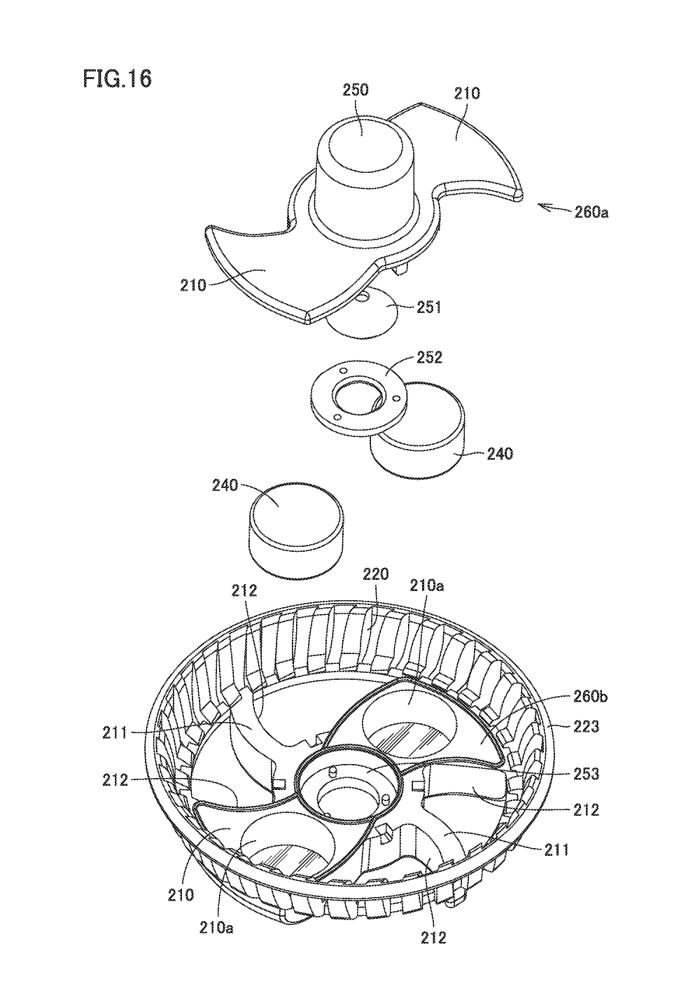

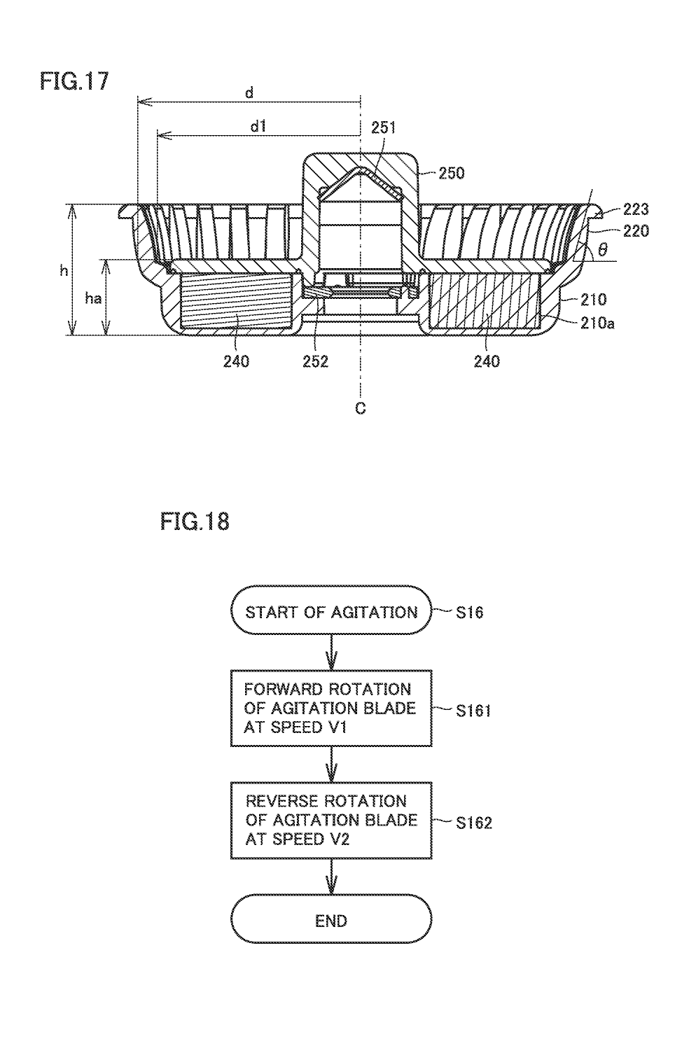

A structure of agitation blade 550 in the present embodiment will now be described with reference to FIGS. 14 to 17. FIG. 14 is a plan view showing a shape of agitation blade 550, FIG. 15 is a perspective view showing the shape of agitation blade 550, FIG. 16 is an exploded perspective view showing a structure of agitation blade 550, and FIG. 17 is a cross-sectional view along the line XVII-XVII in FIG. 14.

Referring to FIGS. 14 and 15, agitation blade 550 includes in the center, cylindrical core 250 in which a rotation shaft is inserted. Cylindrical core 250 implements a rotation portion having a central axis of rotation (C). A pair of first paddles 210 provided at positions opposed to each other at an angle of 180 degrees and a pair of second paddles 211 provided at positions opposed to each other at an angle of 180 degrees, each at a position rotated by 90 degrees from first paddle 210, extend radially from an outer circumferential surface of cylindrical core 250.

A lower auxiliary ring 222 is provided on an outer circumferential surface of the pair of first paddles 210 and an outer circumferential surface of the pair of second paddles 211. Lower auxiliary ring 222 has such a shape as not producing a resistance in a direction of rotation (a direction shown with an arrow A in the figures). A plurality of blade portions 220 extending toward an upper surface (a first surface) of first paddle 210 and second paddle 211 are provided on lower auxiliary ring 222 so as to surround central axis of rotation C. The plurality of blade portions 220 are provided to be in rotation symmetry with respect to central axis of rotation C. An upper end portion of blade portion 220 is coupled to an upper auxiliary ring 223. Upper auxiliary ring 223 also has a shape not producing a resistance in the direction of rotation, similarly to lower auxiliary ring 222. A detailed shape of blade portion 220 will be described later.

The pair of first paddles 210 has a curved paddle surface 212, which has a prescribed thickness downward (toward a second surface), has a curved shape recessed toward a downstream side when viewed in the direction of rotation, and contributes to agitation in the direction of rotation (the direction shown with arrow A in the figures). Similarly, second paddle 211 has curved paddle surface 212 formed, which has a prescribed thickness downward (toward the second surface), has a curved shape recessed toward the downstream side when viewed in the direction of rotation, and contributes to agitation in the direction of rotation (the direction shown with arrow A in the figures). Paddle surfaces 212 are provided at four locations, and four spaces 210h in total are formed between first paddles 210 and second paddles 211. Permanent magnet 240 is embedded in the pair of first paddles 210.

Referring to FIGS. 16 and 17, cylindrical core 250 and the pair of first paddles 210 include an integrally formed cover 260a. A cylindrical accommodation portion 210a for accommodating permanent magnet 240 is provided in a paddle main body 260b of first paddle 210. Rotation is transmitted with magnetic force to permanent magnet 240 embedded in the pair of first paddles 210, by a contactless rotational drive mechanism (agitation motor unit 140 and permanent magnet 141). In order to enhance holding capability owing to magnetic force during rotational drive, magnets are desirably provided at two locations.

A through hole 253 in which the rotation shaft is inserted is provided between the pair of first paddles 210. A conical cap 251 is accommodated in cylindrical core 250 for smooth rotation of agitation blade 550 with a tip end of the rotation shaft being in point contact. A ring seal 252 for ensuring water tightness is fitted in between cover 260a and paddle main body 260b.

A shape of blade portion 220 will now be described with reference to FIG. 17. An angle of inclination θ spreading outward in an upward direction is provided in blade portion 220. Angle of inclination θ is set, for example, to approximately 75 degrees. Depending on angle of inclination θ, agitation blade 550 can obtain high agitation force with an outer shape being the same, or load imposed on a rotational drive portion can be lowered with agitation force being the same.

Depending on angle of inclination θ, ease in cleaning of agitation blade 550 improves. An area where height ha of first paddle 210 and second paddle 211 produces a resistance (contributes to agitation force) in the direction of rotation as shown in FIG. 17 with respect to a total height h of agitation blade 550 is defined. In the present embodiment, desirably, h=9.5 mm and ha=5.5 mm. Blade portion 220 desirably has an inner diameter d1=φ 30 mm and an outer diameter d=φ 32 mm.

According to such a construction, an effect of foaming by intake of air from a water surface in an agitation operation which will be described later and an effect of agitation by paddle surfaces 212 of first paddle 210 and second paddle 211 can both be achieved. In order to realize the effect of foaming, a distance between the water surface and the upper end of the blade should be ensured, and in order to decrease a minimal volume of foaming, total height h should be minimized. On the other hand, height ha of paddle surface 212 should be ensured in order to ensure agitation force, and the construction as above is preferred in order to achieve both of them. According to the construction of the present embodiment, foaming and agitation performance for a minimum volume of 150 cc has been confirmed in the agitation tank having inner diameter φ of 100 mm.

The construction of agitation blade 550 is not limited to the construction as above, and modification as appropriate can be made so long as a shape of a sirocco fan which has a blade portion provided to be able to take in air and an agitation contribution portion contributing to agitation is provided.

(Agitation Operation)

In the present embodiment, control portion 110 controls the agitation blade drive portion so as to switch between forward rotation and reverse rotation of agitation blade 550. Details of the step of starting agitation will be described with reference to FIG. 18. FIG. 18 is a flowchart showing details of the step of starting agitation.

In step 16, when agitation of tea leaf powders and hot water by agitation unit 500 is started, initially, in a step 161, control portion 110 controls agitation motor unit 140 such that agitation blade 550 rotates in a forward direction at a speed V1. In this case, the agitation blade preferably rotates at 2000 rpm. A duration of step 161 is preferably approximately from 10 seconds to 30 seconds.

Then, in a step 162, control portion 110 controls agitation motor unit 140 such that agitation blade 550 rotates in a reverse direction at a speed V2 lower than speed V1. In this case, the agitation blade preferably rotates at 1000 rpm. A duration of step 162 is preferably approximately from 10 seconds to 30 seconds.

Thus, control portion 110 controls agitation motor unit 140 such that agitation blade 550 rotates in the reverse direction after it rotates in the forward direction. Step 161 and step 162 may be repeated. Namely, forward rotation and reverse rotation of agitation blade 550 may be repeated.

A speed of rotation of agitation blade 550 can be varied as appropriate depending on an amount of a liquid supplied into agitation tank 510 and an amount of tea leaf powders introduced into agitation tank 510. Details of the step of starting agitation described above are applicable to all of the first preparation flow to the third preparation flow described above.

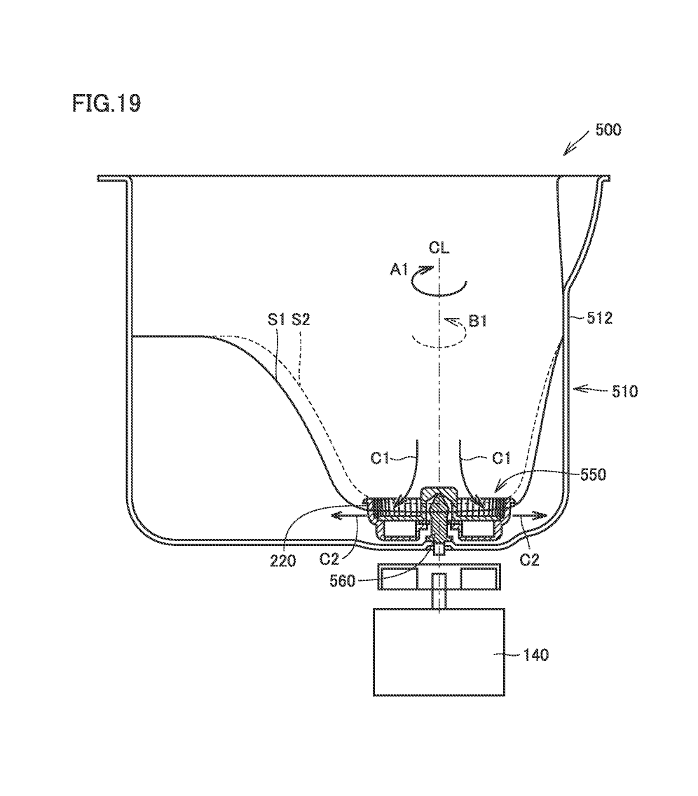

An agitation operation by the agitation blade will be described with reference to FIG. 19. FIG. 19 is a diagram showing an agitation operation by the agitation blade. In FIG. 19, a direction shown with an arrow A1 represents forward rotation of agitation blade 550 and a direction shown with an arrow B1 represents reverse rotation of agitation blade 550. A liquid surface S1 during forward rotation of agitation blade 550 is shown with a solid line and a liquid surface S2 during reverse rotation of agitation blade 550 is shown with a dashed line.

In forward rotation of agitation blade 550, as a result of an agitation action by agitation blade 550, force in a direction substantially orthogonal to central axis of rotation C is applied to the liquid. Consequently, liquid surface S1 in a central portion including the central axis of rotation is lowered, and an upper portion of agitation blade 550 is exposed through liquid surface S1.

Thus, in a region of agitation blade 550 exposed through liquid surface Sl, air can be taken into the liquid as shown with an arrow C1. At the same time, as shown with an arrow C2, air and the liquid to be agitated are sent from the central portion to an outer circumferential portion of agitation blade 550, and powders and the liquid are agitated while air is efficiently taken into the liquid.

As blade portion 220 of agitation blade 550 passes by an interface between air and liquid surface S1, large foams are crushed and fine foams can be created.

When switching from forward rotation of agitation blade 550 to reverse rotation of agitation blade 550 is made, water flows different in direction of travel collide with each other so that the agitation action can be enhanced. By lowering a speed during reverse rotation, a liquid surface S2 in a state that rotation is stable with lowering in speed is higher than liquid surface S1. Here, the upper portion of agitation blade 550 is exposed through liquid surface S2.

As the speed is lowered in reverse rotation, intake of air into the liquid can be suppressed and formation of large foams can be suppressed. By crushing large foams created during forward rotation with blade portion 220 exposed through liquid surface S2, finer foams can be created. Consequently, agitation and foaming can both be achieved.

The agitation operation as described above is effective also in cleaning of agitation tank 510 after use. As agitation blade 550 rotates as repeating forward rotation and reverse rotation so that water flows different in direction of travel collide with each other, a mixture of tea leaf powders and the liquid which adheres to agitation tank 510 after use can be diffused in a cleaning solution.

(Position of Introduction of Tea Leaf Powders)

Since powders are not used in a conventional agitation unit capable of agitating only a liquid such as milk so as to create fine foams, a position of introduction of powders has not sufficiently been studied. If positions of introduction of powders are varied, powders cannot sufficiently be agitated and some powders remaining as a lump even after agitation are concerned.

In the present embodiment, since powder inlet 531 for introducing tea leaf powders grated by milling unit 300 is provided in agitation cover 530 as described above, positions of introduction of tea leaf powders are stable and agitation of tea leaf powders can be improved. Powder inlet 531 is provided at a position not superimposed on agitation blade 550 when viewed in the direction of the central axis of rotation of agitation blade 550. With such a construction, direct contact of tea leaf powders with agitation blade 550 and resultant scattering of the tea leaf powders can be prevented.

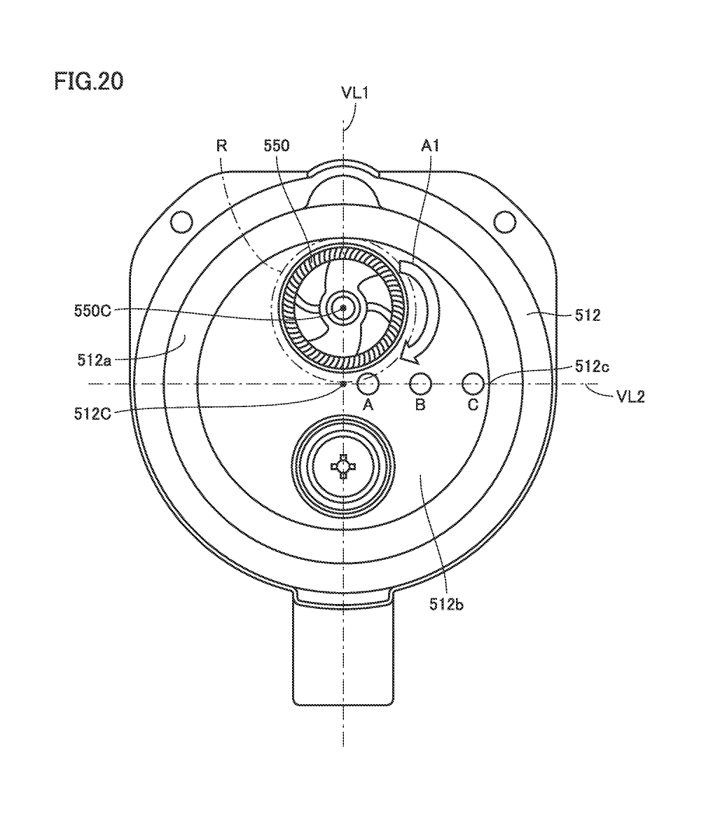

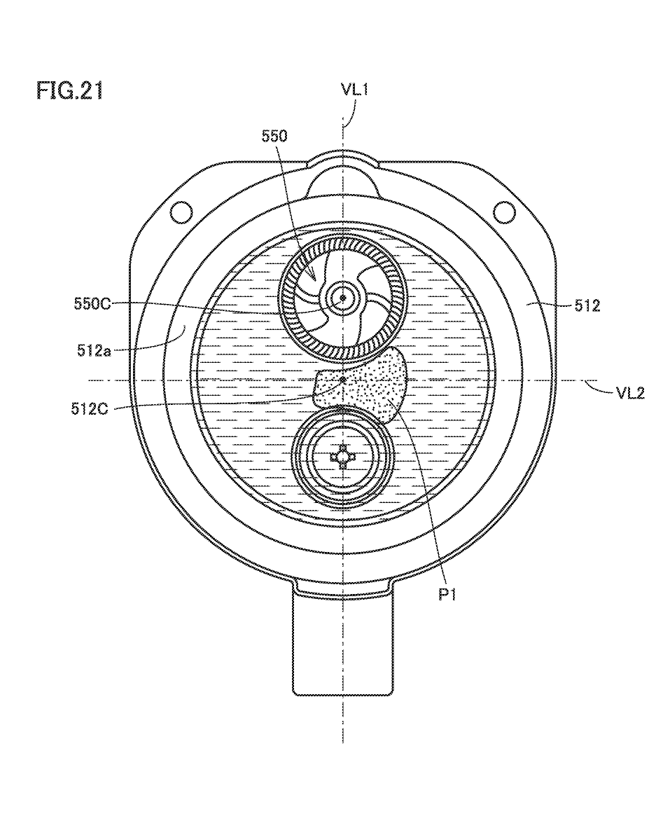

In order to further study details about a position of introduction of tea leaf powders, a state of tea leaf powders after agitation was observed at three positions of introduction. A position of introduction of tea leaf powders and a state of tea leaf powders after agitation will be described with reference to FIGS. 20 to 23. FIG. 20 is a diagram showing a position of introduction of tea leaf powders in the agitation tank. FIGS. 21 to 23 are diagrams showing states of tea leaf powders after agitation when tea leaf powders were dropped in an A region to a C region shown in FIG. 20.

As shown in FIG. 20, thermally insulated tank 512 of agitation tank 510 has a bottom surface portion 512b and a circumferential wall portion 512a erected from a circumference of bottom surface portion 512b. When viewed in the direction of the central axis of rotation of agitation blade 550, a straight line passing through a center 512C of bottom surface portion 512b and a center 550C of agitation blade 550 is defined as a first virtual line VL1 and a straight line orthogonal to first virtual line VL1 at center 512C of bottom surface portion 512b on bottom surface portion 512b is defined as a second virtual line VL2.

The A region, a B region, and the C region are arranged on second virtual line VL2. The A region to the C region are regions defined by projecting powder inlet 531 provided in agitation cover 530 on bottom surface portion 512b along the direction of the central axis of rotation of agitation blade 550. The A region to the C region have an annular shape. The shape of powder inlet 531 is not limited to the annular shape and can be varied as appropriate.

The A region is close to agitation blade 550, and arranged on second virtual line VL2 in a portion slightly to the right of center 512C of bottom surface portion 512b. A part of the A region is located in an annular region R of which radius is defined by a line connecting center 512C of bottom surface portion 512b and center 550C of agitation blade 550 to each other when viewed in the direction of the central axis of rotation of agitation blade 550.

The B region is located between the A region and the C region, and arranged on second virtual line VL2, substantially in the center between center 512C of bottom surface portion 512b and a boundary portion 512c between bottom surface portion 512b and circumferential wall portion 512a. The B region is arranged so as not to be superimposed on annular region R.

The C region is far from agitation blade 550, and arranged on second virtual line VL2, in the vicinity of circumferential wall portion 512a. The C region is arranged so as not to be superimposed on annular region R.

After 3 g of tea leaf powders is introduced onto each of the A region to the C region, 150 cc of hot water was supplied into agitation tank 510 and the tea leaf powders and hot water were agitated by agitation blade 550. Here, a speed of rotation of agitation blade 550 was set to 2000 rpm and agitation for 45 seconds was carried out.

As shown in FIG. 21, when tea leaf powders were introduced in the A region, creation of fine foams could be confirmed, however, a relatively great lump P1 of tea leaf powders remained in the vicinity of center 512C of bottom surface portion 512b.

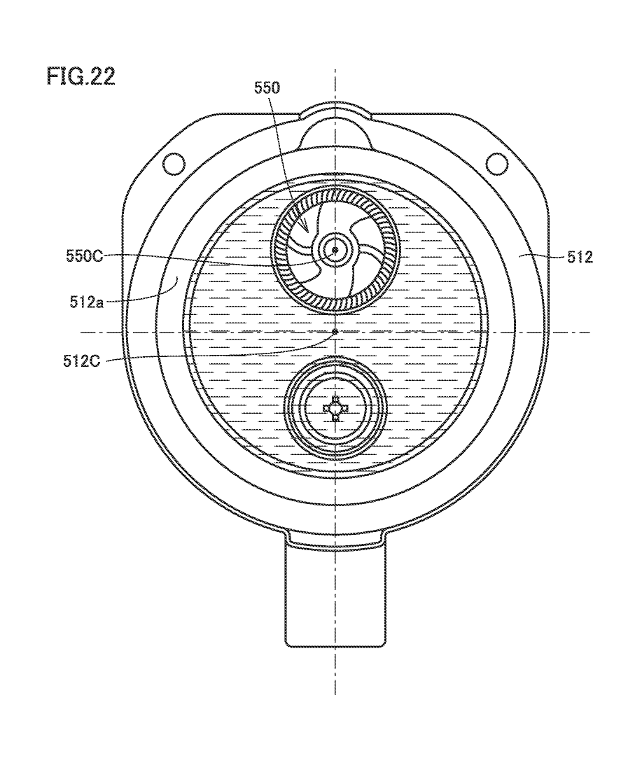

As shown in FIG. 22, when tea leaf powders were introduced in the B region, creation of fine foams could be confirmed. It was confirmed that no lump of tea leaf powders remained and tea leaf powders were satisfactorily agitated.

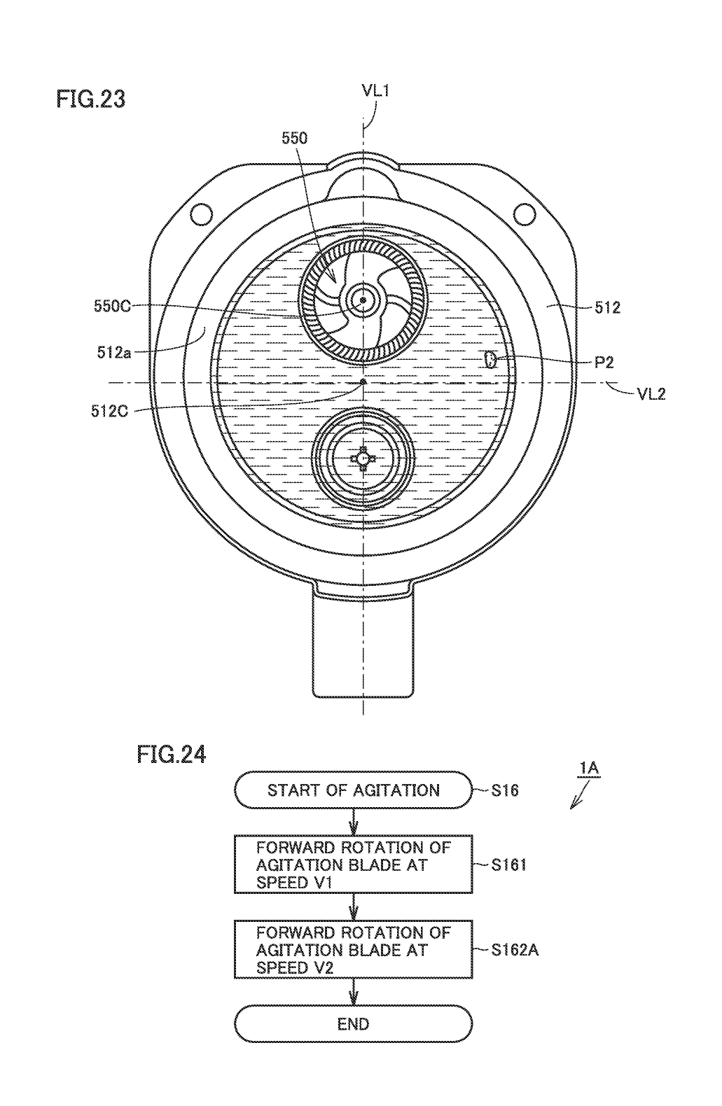

As shown in FIG. 23, when tea leaf powders were introduced in the C region, creation of fine foams could be confirmed. It was confirmed that, though a lump P2 of tea leaf powders slightly remained in the vicinity of circumferential wall portion 512a, tea leaf powders were sufficiently agitated in a beverage except for lump P2.

It can be concluded from the results above that, by providing powder inlet 531 so as not to be superimposed on annular region R of which radius is defined by the line connecting center 512C of bottom surface portion 512b and center 550C of agitation blade 550 to each other when viewed in the direction of the central axis of rotation of agitation blade 550, formation of a lump of tea leaf powders can be suppressed, fine foams can be created, and at the same time, tea leaf powders can sufficiently be agitated.

It can be concluded that, by providing powder inlet 531 so as to be located on second virtual line VL2, substantially in the center between center 512C of bottom surface portion 512b and boundary portion 512c between bottom surface portion 512b and circumferential wall portion 512a when viewed in the direction of the central axis of rotation of agitation blade 550, formation of a lump of tea leaf powders can further be suppressed, fine foams can be created, and at the same time, tea leaf powders can sufficiently be agitated.

### Second Embodiment

Details of the step of starting agitation in a beverage preparation apparatus 1A in the present embodiment will be described with reference to FIG. 24. FIG. 24 is a flowchart showing details of the step of starting agitation.

Beverage preparation apparatus 1A in the present embodiment is different from the beverage preparation apparatus in the first embodiment in that the control portion is not necessarily configured to control a drive portion so as to switch between forward rotation and reverse rotation of the agitation blade and substantially the same in other features. Therefore, only an operation of the agitation blade in the step of starting agitation is different.

In beverage preparation apparatus 1A in the present embodiment, when agitation of tea leaf powders and hot water in agitation unit 500 is started in step 16, initially, in step 161, control portion 110 controls agitation motor unit 140 such that agitation blade 550 rotates in a forward direction at speed V1. In this case, the agitation blade preferably rotates at 2000 rpm. A duration of step 161 is preferably approximately from 10 seconds to 30 seconds.

Then, in step 162, control portion 110 controls agitation motor unit 140 such that agitation blade 550 rotates in the forward direction at speed V2 lower than speed V1. In this case, the agitation blade preferably rotates at 1000 rpm. A duration of step 162 is preferably approximately from 10 seconds to 30 seconds.

Step 161 and step 162 may be repeated. Namely, increase and decrease in speed of rotation of agitation blade 550 may be repeated. A speed of rotation of agitation blade 550 can be varied as appropriate depending on an amount of a liquid supplied into agitation tank 510 and an amount of tea leaf powders introduced into agitation tank 510.

In such an operation of agitation blade 550, when a rotation speed lowers, a liquid surface varies and the liquid moves also in the vertical direction. Consequently, agitation force is improved. While a rotation speed is low, a state that the upper portion of agitation blade 550 is exposed through the liquid surface is preferably maintained.

In this case, intake of air into the liquid can be suppressed and formation of large foams can be suppressed. By crushing large foams created at the time when a rotation speed is high with blade portion 220 exposed through the liquid surface, finer foams can be created. Consequently, agitation and foaming can both be achieved.

As set forth above, in the present embodiment, control portion 110 controls the drive portion such that agitation blade 550 rotates at the first speed and thereafter rotates at the second speed lower than the first speed. An effect substantially the same as in the first embodiment is thus obtained.

### Third Embodiment

In the conventional agitation unit capable of agitating only a liquid such as milk so as to create fine foams, an amount of a liquid supplied into the agitation tank has been sensed based on a full-condition indicator indicating that a sufficient liquid has been supplied into the agitation tank. In such a case, a liquid has be supplied until the full-condition indicator is turned on, and proper agitation in accordance with a desired amount of liquid may not be performed. When a sensor is arranged in the agitation tank, the sensor should be disposed at each prescribed water level, and a structure becoming complicated is concerned.

The present embodiment aims to sense an amount of a liquid supplied into the agitation tank with a simplified configuration.

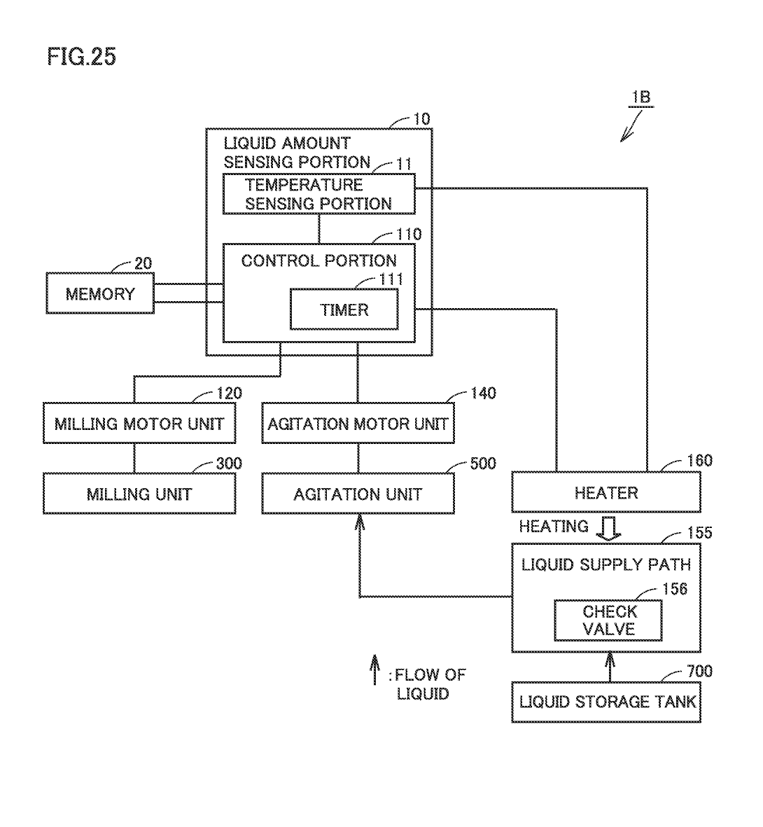

A configuration of a beverage preparation apparatus 1B in the present embodiment will be described with reference to FIG. 25. FIG. 25 is a block diagram showing the configuration of the beverage preparation apparatus.

Beverage preparation apparatus 1B in the present embodiment is different from beverage preparation apparatus 1 in the first embodiment in further including a liquid amount sensing portion 10 and a memory 20, and substantially the same in other features. A flow of preparation of a beverage in the present embodiment is basically in conformity with the preparation flow in the first embodiment.

A check valve 156 prevents backflow of a liquid in liquid supply path 155 to liquid storage tank 700. Therefore, when a pressure in liquid supply path 155 is equal to or higher than a prescribed pressure as the liquid in liquid supply path 155 is heated by heater 160 representing the heating device, the liquid is supplied to agitation tank 510. Check valve 156 is provided on one end side of hot water supply pipe 150 connected to liquid storage tank 700.

Liquid amount sensing portion 10 senses an amount of a liquid supplied to agitation tank 510. Liquid amount sensing portion 10 is implemented by a temperature sensing portion 11 which senses a temperature of heater 160 and control portion 110. For example, a thermistor can be adopted as temperature sensing portion 11. Temperature sensing portion 11 is provided as being in contact with an outer surface of heater 160. Control portion 110 includes a timer 111. Control portion 110 counts a duration of power supply to heater 160 by means of timer 111.

Information on relation between a duration of power supply to heater 160 obtained in advance through experiments and an amount of a liquid supplied from liquid supply path 155 to agitation tank 510 is stored in memory 20.

Memory 20 outputs information on an amount of a liquid to control portion 110 based on the information on the duration of power supply input from control portion 110. Liquid amount sensing portion 10 thus senses an amount of a liquid supplied to agitation tank 510 based on the duration of power supply to heater 160.

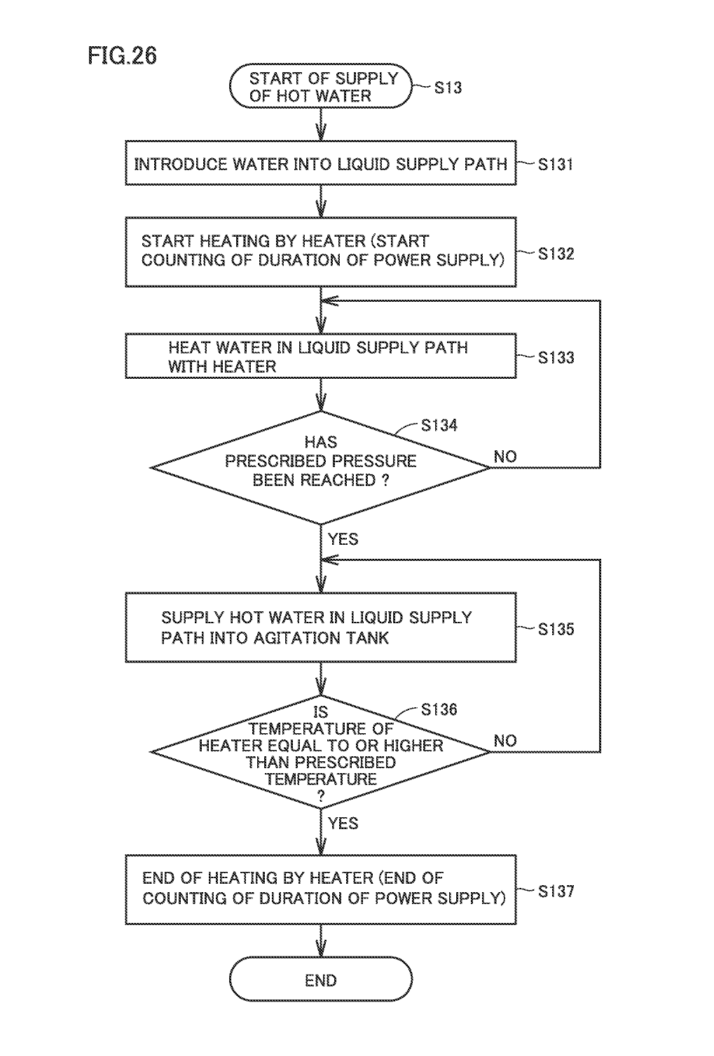

Details of the step of starting supply of hot water will be described with reference to FIG. 26. FIG. 26 is a flowchart showing details of the step of starting supply of hot water.

In step 13, when supply of hot water from apparatus main body 100 to agitation unit 500 is started, initially, water is introduced from liquid storage tank 700 into liquid supply path 155 in a step 131. Then, in a step 132, control portion 110 allows power supply to heater 160 and starts heating by heater 160. Here, counting of a duration of power supply to heater 160 by timer 111 is started.

In succession, in a step 133, water in liquid supply path 155 is heated by heater 160. As water in liquid supply path 155 is heated, a pressure in liquid supply path 155 increases.

When heated water in liquid supply path 155 is boiled and a pressure in liquid supply path 155 reaches a prescribed pressure or higher (a step 134; YES), a step 135 is performed. When heating is insufficient and a pressure in liquid supply path 155 is lower than the prescribed pressure (step 134: No), control portion 110 has heater 160 continue a heating operation until the pressure in liquid supply path 155 reaches the prescribed pressure.

Then, when the pressure in liquid supply path 155 reaches the prescribed pressure, hot water in liquid supply path 155 is supplied to agitation tank 510 in step 135. In this state, check valve 156 prevents backflow of hot water in liquid supply path 155 to liquid storage tank 700. Thus, hot water in liquid supply path 155 is supplied to agitation tank 510 in a stable manner.

In succession, in a step 136, control portion 110 determines whether or not a temperature of heater 160 is equal to or higher than a prescribed temperature based on a result of sensing of a temperature by temperature sensing portion 11. When water in liquid supply path 155 is totally supplied to the agitation tank, heat from heater 160 is no longer transmitted to water and the temperature of heater 160 increases. Therefore, by determining whether or not a temperature of heater 160 is equal to or higher than a prescribed temperature, whether or not water in liquid supply path 155 has totally been supplied to the agitation tank can be determined.

When it is determined that the temperature of heater 160 is equal to or higher than the prescribed temperature (step 136: YES), a step 137 is performed. When it is determined that the temperature of heater 160 is lower than the prescribed temperature (step 136: No), control portion 110 maintains power supply to heater 160 so as to continue heating until the temperature of heater 160 reaches the prescribed temperature or higher.

Then, in step 137, control portion 110 stops power supply to heater 160 so as to stop the heating operation by heater 160. Here, counting of a duration of power supply to heater 160 by timer 111 ends. An operation for supply of hot water thus ends.

Information on a duration of power supply to heater 160 counted by timer 111 is input to memory 20. Memory 20 outputs information on an amount of a liquid to control portion 110 based on the input information. Liquid amount sensing portion 10 thus senses an amount of a liquid supplied to agitation tank 510, based on the duration of power supply to heater 160.

Control portion 110 controls an operation of agitation blade 500 in next step 16 (see FIG. 5) based on the information on the amount of a liquid supplied to agitation tank 510. When control portion 110 determines that the amount of a liquid supplied to agitation tank 510 is small, it lowers the number of rotations of agitation blade 550. When control portion 110 determines that the amount of a liquid supplied to agitation tank 510 is large, it increases the number of rotations of agitation blade 550. By thus controlling an agitation operation in accordance with an amount of a liquid supplied to agitation tank 510 in the step of starting agitation, a beverage can be prepared under a proper condition. A beverage can thus more elaborately be finished.

When desired hot water is to be supplied to agitation tank 510 regardless of an amount of water in liquid storage tank 700, heating by heater 160 may be stopped at the time when a duration of power supply to heater 160 in accordance with a desired amount of hot water has elapsed.

In the present embodiment, by detecting an amount of a liquid in accordance with a duration of power supply to heater 160, a range in which an amount of a liquid can be sensed is wider than in a case that a sensor is disposed at each prescribed water level for sensing a water level in agitation tank 510. An amount of a liquid supplied to the agitation tank can be sensed with a simplified configuration such as temperature sensing portion 11 and timer 111, without installing a bulky component. Furthermore, by sensing an amount of a liquid supplied to agitation tank 510, an agitation operation can properly be controlled in accordance with an amount of a liquid.

Details of the step of starting agitation described above are applicable to all of the first preparation flow to the third preparation flow in the present embodiment, to which the first preparation flow to the third preparation flow in the first embodiment described above are applied mutatis mutandis.

### Fourth Embodiment

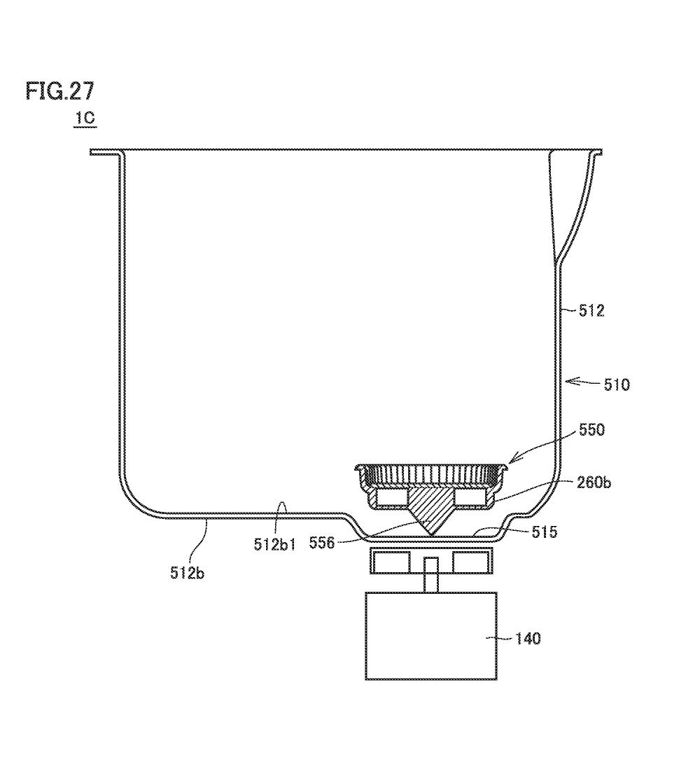

A beverage preparation apparatus 1C in the present embodiment will be described with reference to FIG. 27. FIG. 27 is a vertical cross-sectional view showing a part of the agitation unit and a main body structure of the beverage preparation apparatus.

Beverage preparation apparatus 1C in the present embodiment is different from beverage preparation apparatus 1 in the first embodiment in construction of agitation tank 510 and agitation blade 550.

Rotation shaft 560 is not provided in the bottom surface portion of agitation tank 510 but a rotation shaft 556 is provided on a side of agitation blade 550. When control portion 110 has agitation motor unit 140 drive and has permanent magnet 141 rotate, agitation blade 550 rotates in a stable manner while keeping balance based on the principles of a spinning top. Rotation shaft 560 is formed integrally with the paddle main body.

A water flow generated by rotation of first paddle 210 and second paddle 211 impinges to a lower portion of tea leaf powders introduced onto bottom surface portion 512b, so that tea leaf powders can more effectively be agitated. Therefore, a recess portion 515 is preferably provided in a portion of bottom surface portion 512b where agitation blade 550 is placed such that lower surfaces of first paddle 210 and second paddle 211 are proximate to a bottom surface 512b1. In this case, recess portion 515 is preferably provided such that the lower surfaces of first paddle 210 and second paddle 211 do not come in contact with bottom surface 512b1 and are not located below bottom surface 512b1.

According to such a construction as well, the effect the same as in the first embodiment is obtained. With rotation shaft 560 being provided on the side of agitation tank 510, bumping a hand against rotation shaft 560 during cleaning has been concerned. By providing rotation shaft 556 on the side of agitation blade 550, however, such a concern as bumping a hand during cleaning is eliminated and agitation tank 510 can readily and safely be cleaned.

Since such a concern as bumping of a hand during cleaning is eliminated, a degree of freedom in design of a shape of a tip end portion of rotation shaft 556 increases. By shaping a tip end of rotation shaft 556 to be sharper, rotation loss due to friction can be mitigated and generation of noise can be suppressed.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1, 1A, 1B, 1C beverage preparation apparatus; 10 liquid amount sensing portion; 11 temperature sensing portion; 20 memory; 100 apparatus main body; 110 control portion; 111 timer; 120 milling motor unit; 130 milling driving force coupling mechanism; 140 agitation motor unit; 140A contactless table; 141 permanent magnet; 150 hot water supply pipe; 155 liquid supply path; 156 check valve; 160 heater; 170 hot water supply nozzle; 171 supply port; 180 unit attachment portion; 190 agitation tank attachment portion; 195 liquid storage tank attachment portion; 210 first paddle; 210a accommodation portion; 210h space; 211 second paddle; 212 paddle surface; 222 lower auxiliary ring; 223 upper auxiliary ring; 250 cylindrical core; 251 conical cap; 252 ring seal; 253 through hole; 260a cover; 260b paddle main body; 300 milling unit; 300w window for coupling; 310 milling case; 310b upper end opening portion; 311 storage portion; 312 discharge path; 312a outlet port; 320 hopper portion; 321 top plate portion; 322 cylindrical portion; 323 opening portion; 325 object-to-be-grated inlet; 330 cover portion for object to be grated; 340 lower mill portion support portion; 341 main body portion; 342 protrusion portion; 343 powder scraping portion; 344 groove portion; 345 milling shaft; 350 lower mill portion; 351 lower mill main body; 352 recess portion; 355 core; 355a base end portion; 356 blade portion; 360 upper mill; 361 through hole; 370 upper mill holding member; 371 bottom surface portion; 371a hole portion; 372 outer cylindrical portion; 373 inner cylindrical portion; 380 spring holding member; 381 spring; 391, 392, 393 rib; 500 agitation unit; 510 agitation tank; 511 exterior holder; 512 thermally insulated tank; 512C center; 512a circumferential wall portion; 512b bottom surface portion; 512c boundary portion; 513 opening portion; 515 recess portion; 520 grip; 530 agitation cover; 531 powder inlet; 532 hot water supply inlet; 540 discharge port opening and closing mechanism; 541 discharge port; 542 operation lever; 543 opening and closing nozzle; 545 discharge portion; 550 agitation blade; 550C center; 552 magnet; 556 rotation shaft; 560 rotation shaft; 700 liquid storage tank; 710 tank main body; 720 lid portion; 800 tea leaf powder tray; and 900 placement base.

1. A beverage preparation apparatus for preparing a beverage with a liquid and powders, comprising:
an agitation unit including an agitation blade which agitates the liquid and the powders and an agitation tank which accommodates the agitation blade;
an agitation blade drive portion which rotationally drives the agitation blade; and
a control portion which controls the agitation blade drive portion,
the agitation blade having a central axis of rotation and being provided with a plurality of blades surrounding the central axis of rotation, and
the control portion controlling the agitation blade drive portion so as to switch between forward rotation and reverse rotation of the agitation blade.

2. The beverage preparation apparatus according to claim 1, wherein
the control portion controls the agitation blade drive portion such that the agitation blade rotates at a first speed during forward rotation and rotates at a second speed lower than the first speed during reverse rotation.

3. A beverage preparation apparatus for preparing a beverage with powders, comprising:
an agitation unit including an agitation blade which agitates the powders and a liquid and an agitation tank which accommodates the agitation blade;
an agitation blade drive portion which rotationally drives the agitation blade; and
a control portion which controls the agitation blade drive portion,
the agitation blade having a central axis of rotation and being provided with a plurality of blades surrounding the central axis of rotation, and
the control portion controlling the agitation blade drive portion such that the agitation blade rotates at a first speed and thereafter the agitation blade rotates at a second speed lower than the first speed.

4. The beverage preparation apparatus according to claim 1, wherein
the agitation tank includes a vessel main body in a cylindrical shape with bottom which has an opening portion opening upward and a lid portion which closes the opening portion,
the lid portion has a powder inlet for introducing the powders into the agitation tank, and
the powder inlet is provided at a position not superimposed on the agitation blade when viewed in a direction of the central axis of rotation.

5. The beverage preparation apparatus according to claim 1, comprising:
a liquid storage tank which stores the liquid;
a liquid supply path connected to the liquid storage tank for supplying the liquid to the agitation tank;
a heating device which heats the liquid in the liquid supply path;
a check valve which is provided in the liquid supply path and prevents backflow of the liquid in the liquid supply path to the liquid storage tank as the liquid is heated by the heating device; and
a liquid amount sensing portion which senses an amount of the liquid supplied to the agitation tank, wherein
the liquid amount sensing portion includes a temperature sensing portion which senses a temperature of the heating device and the control portion,
a temperature of the heating device varies depending on an amount of the liquid in the liquid supply path, which fluctuates as the liquid is supplied to the agitation tank,
the control portion turns off the heating device when a temperature of the heating device sensed by the temperature sensing portion exceeds a prescribed temperature, and counts a duration of power supply until the heating device is turned off and
the liquid amount sensing portion senses an amount of the liquid supplied to the agitation tank based on the duration of power supply.
